(19) United States
(12) Patent Application Publication
(10) Pub. No.: US 2023/0361548 A1
(43) Pub. Date: Nov. 9, 2023

(54) ELECTRICAL JUNCTION BOX

(71) Applicant: Sumitomo Wiring Systems, Ltd., Yokkaichi-shi (JP)

(72) Inventors: Maiko ODA, Yokkaichi-shi, Mie (JP); Takumi EJIMA, Yokkaichi-shi, Mie (JP); Keiji MATSUOKA, Yokkaichi-shi, Mie (JP); Kenichiro TAKADA, Yokkaichi-shi, Mie (JP)

(21) Appl. No.: 17/760,168

(22) PCT Filed: Jan. 22, 2021
(86) PCT No.: PCT/JP2021/002211

§ 371 Date: Aug. 4, 2022

(30) Foreign Application Priority Data
Feb. 5, 2020 (JP) 2020-017980

(51) Int. Cl. H02G 3/16

(52) U.S. Cl. CPC H02G 3/16

(57) ABSTRACT

An electrical junction box for a vehicle includes a bus bar, and the bus bar is provided with a through hole for transferring the bus bar. The bus bar can be efficiently transferred by engaging hooks provided at a leading end of a pin chuck device with the transfer through hole, for example.

### CROSS-REFERENCE TO RELATED APPLICATIONS

This application is the U.S. national stage of PCT/JP2021/002211 filed on Jan. 22, 2021, which claims priority of Japanese Patent Application No. JP 2020-017980 filed on Feb. 5, 2020, the contents of which are incorporated herein.

### TECHNICAL FIELD

The present disclosure relates to an electrical junction box for a vehicle.

### BACKGROUND

Conventionally bus bars have been used to constitute a circuit for allowing a relatively large electric current to flow.

JP 2014-79093A discloses a power supply device that includes a relay having an openable/closable contact and an exciting coil that switches opening/closing of the contact, and that electrically connects the contact of the relay to a bus bar. This bus bar is provided with a heat dissipation mechanism, and thus the bus bar can be used as both a current path and a heat dissipation path. Therefore, this power supply device can improve heat dissipation of the relay.

Meanwhile, when assembling an electrical junction box, a bus bar is transferred onto a substrate by an automatic transfer apparatus, and the bus bar is mounted on the substrate. At this time, until now, the automatic transfer apparatus used a suction device to suction and transfer the bus bar. However, a method involving the use of a suction device is inconvenient because it is difficult to adopt such a method when there is unintended unevenness on the surface of the bus bar, for example, and a plurality of suction devices need to be used when a heavy bus bar is to be transferred.

However, such problems are not considered for the power supply device disclosed in JP 2014-79093A, and such problems cannot be solved.

In view of this, this disclosure aims to provide an electrical junction box that can be more efficiently assembled.

### SUMMARY

An electrical junction box according to an embodiment of this disclosure is an electrical junction box for a vehicle provided with a bus bar, and the bus bar is provided with a through hole for transferring the bus bar.

### Advantageous Effects of the Present Disclosure

According to this disclosure, it is possible to provide an electrical junction box that can be more efficiently assembled.

### BRIEF DESCRIPTION OF DRAWINGS

FIG. 1 is a perspective view of an electrical junction box according to Embodiment 1.

FIG. 2 is a bottom view showing an internal configuration of an electrical junction box 100 according to Embodiment 1.

FIG. 3 is a perspective view showing an example of a bus bar attached to the electrical junction box according to Embodiment 1.

FIG. 4 is a cross-sectional view taken along line IV-IV in FIG. 3.

FIG. 5 is a perspective view showing an example of a bus bar attached to an electrical junction box according to Embodiment 2.

FIG. 6 is an enlarged view showing a portion of a bus bar attached to an electrical junction box according to Embodiment 3.

### DETAILED DESCRIPTION OF PREFERRED EMBODIMENTS

First, embodiments of this disclosure will be listed and described. Also, at least some of the embodiments described below may be combined as appropriate.

### First Embodiment

An electrical junction box according to a first embodiment of this disclosure is an electrical junction box for a vehicle including a bus bar, and the bus bar is provided with a through hole for transferring the bus bar.

In the first embodiment, a so-called pin chuck device is engaged with a through hole for transferring the bus bar, and then the bus bar can be transferred. Therefore, it is possible to more efficiently assemble the electrical junction box.

### Second Embodiment

With an electrical junction box according to second embodiment of this disclosure, the through hole is formed in a protruding portion that extends from a side edge of the bus bar.

In the second embodiment, the transfer through hole that is used by the pin chuck device to transfer the bus bar is formed in the protruding portion that extends from the side edge of the bus bar. Therefore, it is possible to avoid a decrease in the cross-sectional area of the bus bar as much as possible, and to prevent an increase in resistance in the bus bar.

### Third Embodiment

With an electrical junction box according to a third embodiment of this disclosure, the through hole has an oblong shape extending in a direction in which a current flows through the bus bar.

In the third embodiment, the transfer through hole that is used by the pin chuck device to transfer the bus bar extends in the direction in which a current flows through the bus bar. Thus, it is possible to avoid a decrease in the cross-sectional area in a direction intersecting with the direction in which a current flows, as much as possible, and to prevent an increase in the resistance in the bus bar.

### Fourth Embodiment

With an electrical junction box according to a fourth embodiment of this disclosure, the through hole has a cross shape.

In the fourth embodiment, the transfer through hole that is used by the pin chuck device to transfer the bus bar has a cross shape. Thus, a direction for achieving higher workability may be selected as needed, and the transfer through hole and the pin chuck device can be engaged with each other.

### Fifth Embodiment

With an electrical junction box according to a fifth embodiment of this disclosure, an edge of the through hole is chamfered.

In the fifth embodiment, an edge of the transfer through hole that is used by the pin chuck device to transfer the bus bar is chamfered. Therefore, when the pin chuck device and the transfer through hole are engaged with each other, a leading end of the pin chuck device can be smoothly inserted into the transfer through hole.

An electrical junction box according to an embodiment of this disclosure will be described below with reference to the drawings. Note that the present disclosure is not limited to these examples, but is indicated by the claims, and all changes that come within the meaning and range of equivalency of the claims are intended to be embraced therein.

### Embodiment 1

The following describes an electrical junction box for a vehicle according to an embodiment of this disclosure based on the drawings.

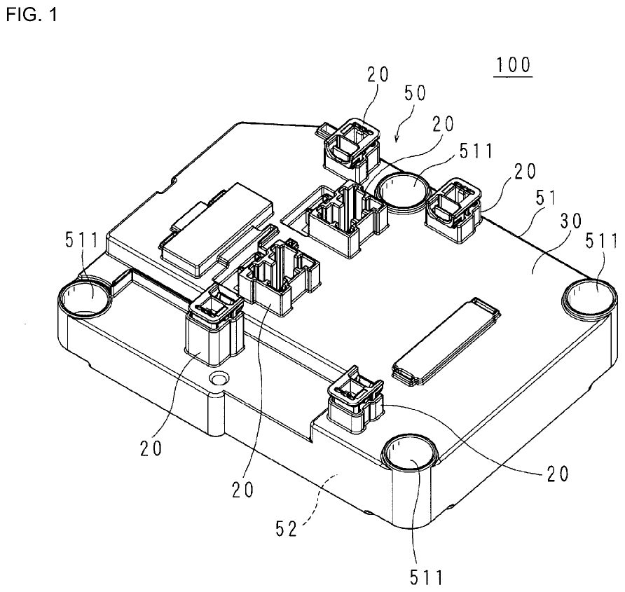

FIG. 1 is a perspective view of an electrical junction box 100 according to Embodiment 1.

The electrical junction box 100 is attached to the outside of a battery pack (not shown) of an EV (Electric Vehicle), for example. The electrical junction box 100 includes a housing 50 on which an electrical component such as a fuse is mounted, for example.

The housing 50 is made of a resin, for example, and includes a lower case 52 and an upper case 51 that covers the lower case 52. The housing 50 is attached to the upper surface of the battery pack of the EV with the lower case 52 on the lower side. Also, the upper case 51 has a ceiling plate 30 that faces the lower case 52.

Hereinafter, for convenience of description, in the electrical junction box 100, the upper case 51 side refers to the upper side, and the lower case 52 side refers to the lower side.

An outer face of the ceiling plate 30 is provided with a plurality of types of connection portions 20 for connection to an external fuse, an external connector, or the like. Also, legs 511 are provided at four portions of the ceiling plate 30. Three of the legs 511 are provided at corners of the ceiling plate 30, and one of the legs 511 is provided at a position where this leg 511 does not interfere with the connection portions 20.

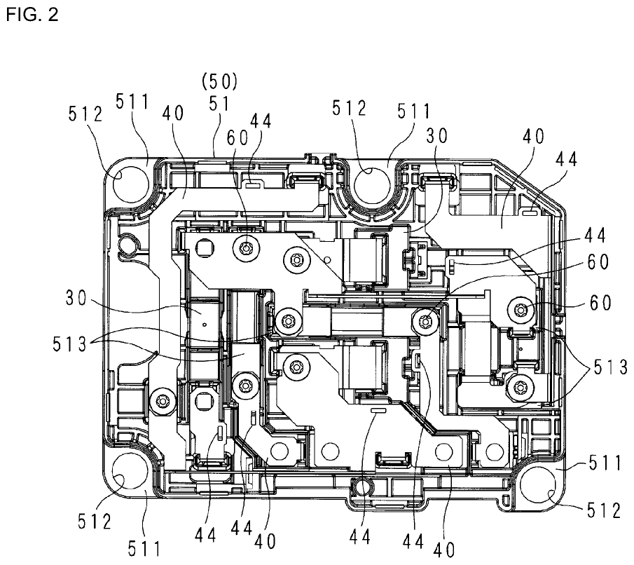

Each leg 511 has a bottomed tubular shape, and a through hole 512 (see FIG. 2) is formed in the bottom of the leg 511. The housing 50 (the electrical junction box 100) can be attached to the battery pack by inserting a screw into the through hole 512 in the leg 511 and screwing the screw into a screw hole in the battery pack of the EV, for example.

FIG. 2 is a bottom view showing an internal configuration of the electrical junction box 100 according to Embodiment 1. FIG. 2 shows a state in which the lower case 52 is detached, for convenience of description.

The upper case 51 has the shape of the housing with an open surface, and bus bars 40 are attached to the inside of the upper case 51 by screws 60 (fixing members).

A plurality of pedestals 513 for attaching the bus bars 40 are formed on the inner face of the ceiling plate 30. The pedestals 513 protrude from the inner face of the ceiling plate 30. The bus bars 40 are attached to the corresponding pedestals 513.

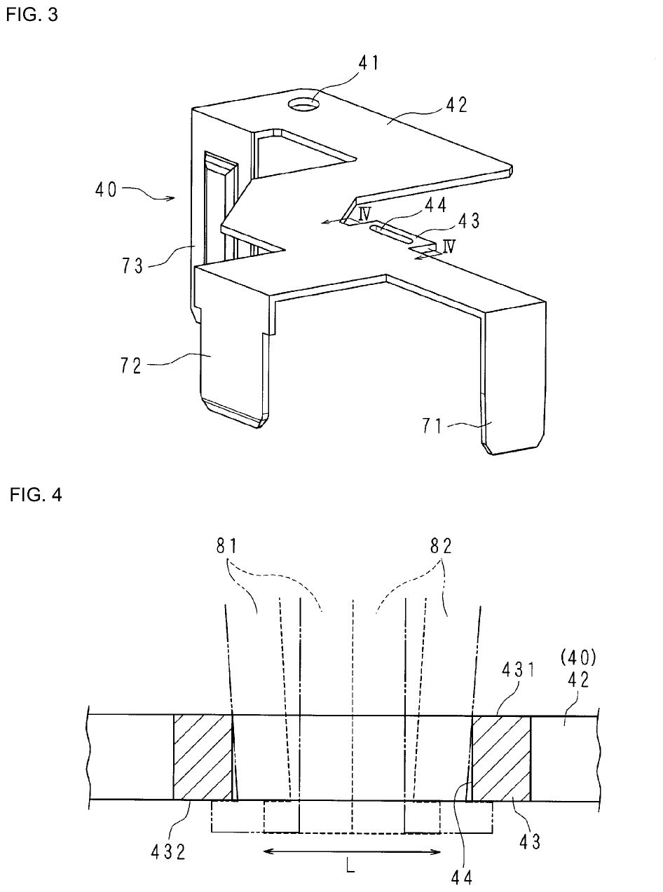

FIG. 3 is a perspective view showing an example of the bus bars 40 attached to the electrical junction box 100 according to Embodiment 1. The bus bars 40 are made of a conductive metal, for example.

The bus bars 40 each have a plate-shaped flat portion 42, and have a plurality of types of terminals 71, 72, and 73 that extend respectively from three side edges of the flat portion 42 in a direction perpendicular to the flat portion 42. The terminals 71, 72, and 73 have shapes that are different from each other.

The flat portion 42 is provided with a through hole 41 for inserting the screw 60 into the bus bar 40. The bus bar 40 is attached to the pedestal 513 (the upper case 51) by inserting the screw 60 into the through hole 41 in the bus bar 40 and screwing the screw 60 into the screw hole in the pedestal 513 (see FIG. 2).

Also, the bus bar 40 is provided with a transfer through hole 44 that is used to transfer the bus bar 40. The transfer through hole 44 is provided in a side edge portion of the flat portion 42.

In the flat portion 42, a protruding portion 43 protrudes from a portion of one side edge of the flat portion 42 in a plane direction. The protruding portion 43 has a rectangular plate shape, and extends as a single body with the flat portion 42. The transfer through hole 44 is provided at a central portion of the protruding portion 43.

The transfer through hole 44 extends through the protruding portion 43 in the thickness direction thereof, and has an oblong shape that extends along the side edge of the flat portion 42.

In other words, the protruding portion 43 extends in a direction in which a current flows through the bus bar 40, and the transfer through hole 44 extends in the longitudinal direction of the protruding portion 43. That is, the transfer through hole 44 extends in a direction in which a current flows through the bus bar 40. In the bus bar 40, a current flows between the terminal 71 and the terminal 72, between the terminal 71 and the terminal 73, and between the terminal 72 and the terminal 73.

Note that the transfer through holes 44 that are respectively formed in the bus bars 40 have the same dimensions (see FIG. 2).

FIG. 4 is a cross-sectional view taken along line IV-IV in FIG. 3. The following describes the transfer of the bus bar 40 when assembling the electrical junction box 100 according to Embodiment 1 with reference to FIG. 4. A pin chuck device is used to transfer the bus bar 40. The leading end portion of this pin chuck device has hooks. For convenience of description, only the hooks of the pin chuck device are shown in FIG. 4.

The leading end portion of the pin chuck device has two hooks 81 and 82 (engagement members) that are bent in an L-shape. The hooks 81 and 82 are configured to come into contact with and separate from each other. The hooks 81 and 82 are bent in opposite directions in contact and separation directions, and have a plate shape. The thickness direction of the hooks 81 and 82 coincides with the width direction of the transfer through hole 44.

Also, in FIG. 4, broken lines are used to illustrate an approaching state in which the hooks 81 and 82 approach each other and come into contact with each other, and line-double dashed lines are used to illustrate a separated state in which the hooks 81 and 82 are separated farthest from each other.

In the approaching state in which the hooks 81 and 82 approach each other, a length L from the end of the hook 81 to the end of the hook 82 in the contact and separation directions is shorter than the length of the transfer through hole 44 in the longitudinal direction thereof. Also, the length of the end portions of the hooks 81 and 82 in a direction that is orthogonal to the contact and separation directions, that is, the thickness thereof, is smaller than the length of the transfer through hole 44 in the lateral direction (the width direction). Therefore, the hooks 81 and 82 of the pin chuck device can be inserted into the transfer through hole 44.

When the bus bar 40 is transferred, the hooks 81 and 82 are set such that the contact and separation directions thereof coincide with the longitudinal direction of the transfer through hole 44, and in the approaching state, the hooks 81 and 82 are inserted into the transfer through hole 44 from one face 431 side of the protruding portion 43, and protrude from another face 432 side (see the broken lines in FIG. 4). Then, the hooks 81 and 82 are separated from each other, resulting in the separated state (see the line-double dashed lines in FIG. 4). At this time, the hooks 81 and 82 are respectively in contact with the edges in the longitudinal direction of the transfer through hole 44, and as shown in FIG. 4, the bent leading end portions of the hooks 81 and 82 are caught on the other face 432, and the hooks 81 and 82 engage with the transfer through hole 44. The pin chuck device (the hooks 81 and 82) transfers the bus bar 40 in the state in which the hooks 81 and 82 are engaged with the transfer through hole 44 in this manner.

In the electrical junction box 100 according to Embodiment 1, the transfer through hole 44 is formed in the bus bar 40 in this manner, and thus it is possible to efficiently and accurately transfer the bus bar 40 using the pin chuck device. Therefore, it is possible to more effectively assemble the electrical junction box 100.

That is, when an electrical junction box is assembled, heretofore, the bus bar was mechanically mounted by transferring the bus bar by the flat portion suctioning the bus bar using a suction device. However, a method involving the use of a suction device is inconvenient because it is difficult to suction the flat portion of a bus bar when there is unintended unevenness on the surface of the flat portion, and a plurality of the suction devices need to be used when a thick (heavy) bus bar for a large current is to be transferred.

In contrast, in the electrical junction box 100 according to Embodiment 1, the transfer through hole 44 is formed in the bus bar 40 as described above, and thus the bus bar 40 can be transferred using the pin chuck device.

Thus, the above method involving the use of a suction device is applicable even when there is unevenness on the surface of the flat portion 42 of the bus bar 40, and a bus bar 40 for a large current can be transferred using one pin chuck device. Therefore, it is possible to efficiently and accurately transfer the bus bar 40, and to more efficiently assemble the electrical junction box 100.

Also, as described above, in the electrical junction box 100 according to Embodiment 1, the transfer through hole 44 is provided in the protruding portion 43 of the bus bar 40 in a direction in which a current flows (in the longitudinal direction of the protruding portion 43). Thus, it is possible to avoid a decrease in the cross-sectional area of the bus bar 40 in a direction intersecting with the direction in which a current flows, as much as possible, and to suppress an increase in the resistance in the bus bar 40.

When the electrical junction box 100 is assembled, the hooks 81 and 82 of the pin chuck device are engaged with the transfer through hole 44 in the bus bar 40 by inserting the hooks 81 and 82 into the transfer through hole 44 and separating the hooks 81 and 82 from each other. Accordingly, the bus bar 40 is held by the hooks 81 and 82. In this state, the hooks 81 and 82 transfer a bus bar 40 onto the corresponding pedestal 513 of the upper case 51.

Then, the bus bar 40 is placed on the pedestal 53, and the engagement of the hooks 81 and 82 with the transfer through hole 44 is released by bringing the hooks 81 and 82 closer to each other.

The screw 60 is inserted into the through hole 41 in the bus bar 40 and screwed into the screw hole in the pedestal 513. Accordingly the bus bar 40 is fixed to the pedestal 513.

The electrical junction box 100 according to Embodiment 1 is not limited to the above description, and may have a configuration in which the transfer through hole 44 is formed at a side edge portion of the flat portion 42 without separately providing the protruding portion 43.

Note that, if a suction device is used in addition to the pin chuck device, the bus bar 40 can be more stably transferred.

### Embodiment 2

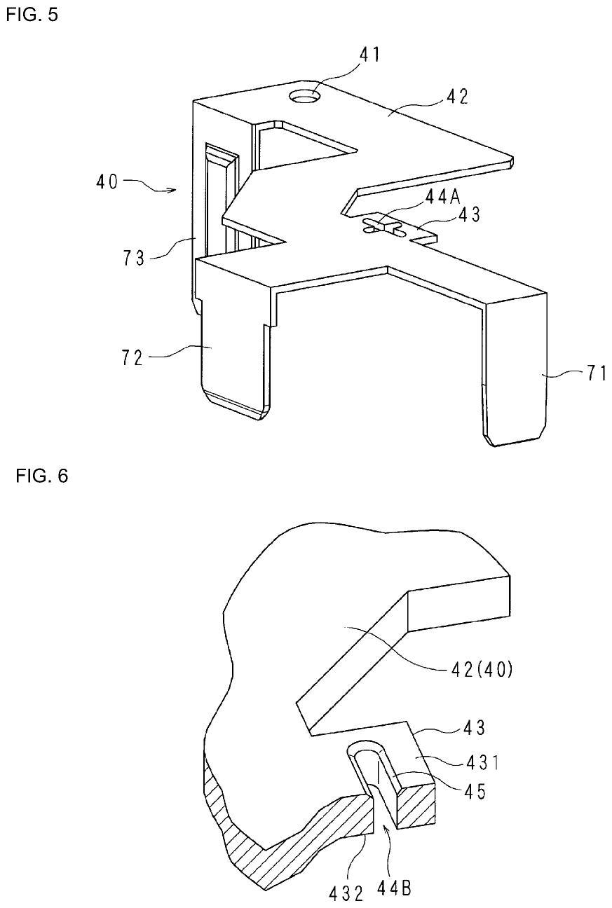

FIG. 5 is a perspective view showing an example of a bus bar 40 attached to an electrical junction box 100 according to Embodiment 2. Similarly to Embodiment 1, the bus bar 40 according to Embodiment 2 includes a flat portion 42 and a plurality of types of terminals 71, 72, and 73 that extend perpendicular to the side edge of the flat portion 42, and a through hole 41 is formed in the flat portion 42.

Also, the bus bar 40 is provided with a transfer through hole 44A that is used to transfer the bus bar 40. The transfer through hole 44A is provided at a side edge portion of the flat portion 42.

A rectangular plate-shaped protruding portion 43 protrudes from a portion of one side edge of the flat portion 42 in a plane direction of the flat portion 42. The protruding portion 43 extends as a single body with the flat portion 42. The transfer through hole 44A is formed at a central portion of the protruding portion 43.

The transfer through hole 44A extends through the protruding portion 43 in the thickness direction thereof, and has a cross shape. That is, the transfer through hole 44A has an elongated hole extending along the side edge of the flat portion 42 and an elongated hole extending in a direction intersecting this elongated hole.

In the electrical junction box 100 according to Embodiment 2, the transfer through hole 44A is formed in the bus bar 40 in this manner, and thus it is possible to efficiently and accurately transfer the bus bar 40 and to more efficiently assemble the electrical junction box 100.

Furthermore, in the electrical junction box 100 according to Embodiment 2, the transfer through hole 44A has a cross shape. Thus, when the hooks 81 and 82 of the pin chuck device are inserted into the transfer through hole 44A from the one face 431 side of the protruding portion 43, the insertion direction can be selected from two directions as needed. Thus, the electrical junction box 100 can be more efficiently assembled by selecting the insertion direction in which the operation amount is minimized in light of the current state of the hooks 81 and 82.

Portions that are the same as those of Embodiment 1 are given the same reference numerals, and detailed description thereof will be omitted.

### Embodiment 3

FIG. 6 is an enlarged view showing a portion of the bus bar 40 attached to an electrical junction box 100 according to Embodiment 3. In a bus bar 40 according to Embodiment 3, a transfer through hole 44B is formed in a protruding portion 43 of the flat portion 42. FIG. 6 shows a state in which the protruding portion 43 is cut at a position of the transfer through hole 44B.

Similarly to Embodiment 1, the bus bar 40 according to Embodiment 3 includes the flat portion 42, a plurality of types of terminals 71, 72, and 73, and a through hole 41 (see FIG. 3).

Also, the bus bar 40 is provided with the transfer through hole 44B that is used to transfer the bus bar 40. The transfer through hole 44B is provided at a side edge portion of the flat portion 42.

The rectangular plate-shaped protruding portion 43 protrudes from a portion of one side edge of the flat portion 42 in a plane direction of the flat portion 42. The protruding portion 43 extends as a single body with the flat portion 42. The transfer through hole 44B is formed at a central portion of the protruding portion 43.

Similarly to Embodiment 1, the transfer through hole 44B extends through the protruding portion 43 in the thickness direction thereof, and has an oblong shape that extends in the longitudinal direction of the protruding portion 43.

In the electrical junction box 100 according to Embodiment 3, the transfer through hole 44B is provided with a chamfered portion 45. Specifically, the chamfered portion 45 is formed at an edge of the transfer through hole 44B, i.e., the edge on one face 431 side of the protruding portion 43 such that the width of the transfer through hole 44B decreases inwardly.

The chamfered portion 45 of the transfer through hole 44B is formed by subjecting the edge of the transfer through hole 44B to C-chamfering, for example.

In the electrical junction box 100 according to Embodiment 3, the transfer through hole 44B is formed in the bus bar 40 in this manner, and thus it is possible to efficiently and accurately transfer the bus bar 40 and to more efficiently assemble the electrical junction box 100.

Also, because the chamfered portion 45 is formed at an edge of the transfer through hole 44B, hooks 81 and 82 of a pin chuck device can be smoothly inserted into the transfer through hole 44B from the one face 431 side of the protruding portion 43. Therefore, it is possible to more efficiently assemble the electrical junction box 100.

Furthermore, although the case where the chamfered portion 45 is formed at the edge of the transfer through hole 44B on the one face 431 side of the protruding portion 43 was described above as an example, there is no limitation to this. A chamfered portion may also be formed at the edge of the transfer through hole 44B on the other face 432 side of the protruding portion 43. In this case, the hooks 81 and 82 can be easily removed from the transfer through hole 44B (engagement of the hooks with the transfer through hole 44B can be easily released).

Furthermore, when the transfer through hole 44B is formed in the protruding portion 43 through pressing, a hole is formed from the one face 431 side of the protruding portion 43. As a result, it is possible to form the chamfered portion 45 simultaneously with the formation of the transfer through hole 44B.

Portions that are the same as those of Embodiment 1 or 2 are given the same reference numerals, and detailed description thereof will be omitted.

The embodiments disclosed herein are to be considered illustrative in all respects and not restrictive. The scope of the present disclosure is defined by the claims and not by the above description, and all changes that come within the meaning and range of equivalency of the claims are intended to be embraced therein.

1. An electrical junction box for a vehicle, comprising a bus bar, wherein the bus bar is provided with a through hole for transferring the bus bar.

2. The electrical junction box according to claim 1, wherein the through hole is formed in a protruding portion that extends from a side edge of the bus bar.

3. The electrical junction box according to claim 1, wherein the through hole has an oblong shape extending in a direction in which a current flows through the bus bar.

4. The electrical junction box according to claim 1, wherein the through hole has a cross shape.

5. The electrical junction box according to claim 1, wherein an edge of the through hole is chamfered.

6. The electrical junction box according to claim 2, wherein the through hole has an oblong shape extending in a direction in which a current flows through the bus bar.

7. The electrical junction box according to claim 2, wherein the through hole has a cross shape.

8. The electrical junction box according to claim 2, wherein an edge of the through hole is chamfered.

9. The electrical junction box according to claim 3, wherein an edge of the through hole is chamfered.

10. The electrical junction box according to claim 3, wherein the through hole is formed in a protruding portion that extends from a side edge of the bus bar and wherein an edge of the through hole is chamfered.

11. The electrical junction box according to claim 4, wherein an edge of the through hole is chamfered.

12. The electrical junction box according to claim 4, wherein the through hole is formed in a protruding portion that extends from a side edge of the bus bar, and wherein an edge of the through hole is chamfered.
